(19) United States
(12) Patent Application Publication
(10) Pub. No.: US 2008/0299476 A1
(43) Pub. Date: Dec. 4, 2008

(54) Toner Formulation

(76) Inventors: Danielle Renee Ashley, Longmont, CO (US); James Robert Combes, Boulder, CO (US); John Joseph Earley, Boulder, CO (US); Lale Gokbudak Lovell, Longmont, CO (US); George Pharris Marshall, Denver, CO (US); Walter Mychajlowskij, Superior, CO (US); Tao Yu, Louisville, CO (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/757,580

(22) Filed: Jun. 4, 2007

(51) Int. Cl. G03G 9/097; G03G 9/00; G03G 9/087

(52) U.S. Cl. 430/108.4; 430/109.1; 430/110.2

(57) ABSTRACT

The present disclosure relates to a method of forming a toner composition, and to a toner composition, that has a controlled particle size distribution, wherein the particle size distribution may be controlled by adjusting the concentration of a charge control additive in a chemical process of toner manufacture. The toner may therefore have a controlled amount of toner particles having diameters of less than or equal to about 4.0 microns. The toner may therefore provide improved resistance to filming on a given printer component.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Invention

The present disclosure relates to toner formulations and in particular a method of controlling particle size distribution in chemically processed toner by incorporation of charge control additives. The control of particle size distribution may then be employed to reduce toner filming in an electrophotographic printer.

2. Description of the Related Art

Toner particles may be formed by chemical methods in which the toner particles are prepared by chemical processes such as suspension polymerization or emulsion aggregation rather than being abraded from larger sized materials by physical processes. Toner compositions so formed may be used in electrophotographic printers and copiers, such as laser printers wherein an image may be formed via use of a latent electrostatic image which is then developed to form a visible image on a drum which may then be transferred onto a suitable substrate.

### SUMMARY OF THE INVENTION

An aspect of this disclosure relates to a method of forming a toner composition and controlling the toner particle diameter distribution. The method includes mixing a pigment and wax dispersion with a polymeric latex and a charge control additive. This may then be followed by adjusting the concentration of charge control additive between about 2.5 to about 5.0% by weight to control the toner particle diameter distribution, and forming toner particles and fusing the particles. The adjustment of charge control additive concentration provides a mixture of toner particles having diameters (D₁) greater than about 4.0 μm and particles having diameters (D₂) less than about 4.0 μm, wherein particles having diameter D₂ are present in an amount of less than about 14.0%. The toner particles so formed may then be transferred to a printer or printer cartridge.

Another aspect of this disclosure relates to a method of forming a toner composition and controlling the toner particle diameter distribution, by again mixing a pigment and wax dispersion with a polymeric latex and a charge control additive. This may then be followed by adjusting the concentration of charge control additive between about 2.5 to about 5.0% by weight to control the toner particle diameter distribution, and forming toner particles and fusing the particles. In this approach, the adjustment of charge control additive concentration provides a mixture of toner particles having diameters (D₁) greater than about 4.0 μm and particles having diameters (D₂) of about 0.6 to about 4.0 μm, wherein particles having diameter D₂ are present in an amount of about 0.1 to about 5.0%, and the particles may also have an average degree of circularity of greater than or equal to about 0.95.

Another aspect of the present disclosure relates to chemically processed toner comprising pigment, wax, charge control agent and a polymer binder, wherein the charge control additive is present at about 2.5 to about 5.0% by weight. The toner composition may include a mixture of particles having diameters (D₁) greater than about 4.0 μm and particles having diameters (D₂) less than about 4.0 μm, wherein particles having diameter D₂ are present in an amount of less than about 14.0%

### DETAILED DESCRIPTION

The present invention relates to a toner formulation and associated methods of preparation, wherein the toner may be a chemically processed toner (CPT) which may include a charge control agent. The toner may be utilized in an image forming device such as a printer, copier, fax, all-in-one device, multi-functional device, etc. The toner may also be incorporated into a printer cartridge which may be utilized in an image forming device to provide toner thereto. Exemplary methods of forming toner by chemical techniques may be found in U.S. Pat. Nos. 6,531,254 and 6,531,256, whose teachings are incorporated by reference.

In the chemical manufacture of toner according to the present disclosure, polymer latexes may be prepared from the polymerization of vinyl type monomers such as styrene and acrylic in the presence of anionic type surfactants. Pigments may be milled in water along with a surfactant that has the same functionality (and ionic charge) as the surfactant employed in the polymer latex. Waxes (polyolefin and carnauba type at about an 80/20 ratio) may also prepared with a surfactant that has the same functionality (and ionic charge) as the surfactant employed in the polymer latex. A charge control agent or additive (CCA) may be included. The polymer latex, pigment latex and wax latex may then be mixed and stirred to ensure a homogenous composition. Acid may then added to reduce the pH and cause flocculation. Flocculation is reference to formation of a “gel” where resin, pigment, wax and CCA may form an aggregated mixture, from particles 1-2 μm in size. The flocculated mixture may then be heated and there is a viscosity drop. The gel collapses and loose (larger) aggregates, e.g., of from 0.5-20 μm size may be formed from the 1-2 μm particles. Base may then be added to increase the pH and reionize the surfactant or one can add additional anionic type surfactants. The temperature may then be raised to about 100-130° C. to bring about coalescence of the particles, which are then washed and dried. Coalescense is reference to fusion of all the components into toner particles.

The addition of the charge control agent (CCA) during the preparation of toner by the above exemplary method of chemical production has now been found to regulate toner particle size distribution and in particular, reduce the percentage of fines in the toner. Fines may be understood as toner particles having a particle size diameter (largest cross-section dimension) of less than or equal to about 4.0 μm, such as particles in the range of about 0.5 to 4.0 μm, including all values and increments therein. More specifically, the toner provided herein, when using a selected amount of CCA in a chemical process for toner preparation, may have fines present at less than or equal to about 14.0% of the toner particles, such as in the range of about 0.1 to 14.0%, including all values and increments therein. Reference to the percent of fines in the toner may be understood herein as a percent based upon the number of particles in a given sample of toner. In addition, as should be apparent, the ability to regulate the amount of fines in the toner, via use of the CCA, may now be accomplished without the need to rely upon other techniques that may physically screen and separately control particle size distribution in a given sample of formed toner.

It may therefore be appreciated that the fines may be present in an amount of less than about 10%, or in an amount of less than about 5.0%. Therefore, the fines may be controlled to be present in an amount of about 0.1-5.0%. Accordingly, during the preparation of toner by chemical methods, and by including a CCA concentration of greater than about 2.5% by weight, the concentration of fines may be regulated and advantageously reduced, thereby controlling filming tendency, as described more fully below. Therefore, in broad context, the concentration of the CCA may be adjusted in an amount between about 2.5-5.0% by weight with the resulting concentration of fines being controlled to a level of between about 0.1-14.0%.

It should be understood herein that a charge control agent may be any chemical compound that may provide a positive or negative charge to a given toner formulation. The addition of certain charge control agents to toner compositions may then assist in the production and stability of a tribocharge within the toner. The charge control agent may also improve image quality when the image is transferred to paper. A CCA may also be capable of stabilising a positive electrostatic charge (positive charging) and/or negative electrostatic charge (negative charging). However, as noted above, the present disclosure now relates to a method of regulating the amount of CCA within the indicated limits in order to influence the percent of fines in a toner, where the CCA may still provide other useful characteristics to a given toner sample.

The charge control agent may be a metal complex of an aromatic acid. Accordingly, such compositions may include the following formula:

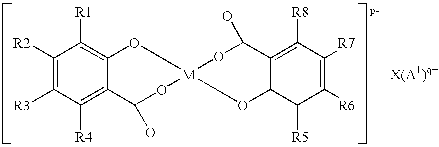

wherein each of R1-R8 may be individually selected from a hydrogen, a hydroxyl group, a normal or branched alkyl group having 1 to 12 carbon atoms, an alkenyl group, an aryl group, an aralkyl group, a halogen or a nitro group; M may be a divalent, trivalent or tetravalent metal; p may be 0, 1 or 2; q may be 1 or 2 (A¹)^{q+} may be H⁺, NH₄⁺, a cation based on an alkali metal (Na, K, etc.), a cation based on an organic amine (aliphatic or primary amine, aliphatic or secondary amine, aliphatic or tertiary amine, etc.) or a quaternary organic ammonium ion; and X may be 0, 1, or 2.

A further exemplary charge control agent may be represented by the following formula:

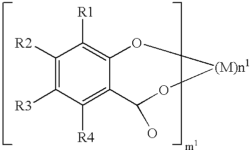

wherein each of R1 to R4 may individually be a hydrogen, a hydroxyl group, a normal or branched alkyl group having 1 to 12 carbon atoms, an alkenyl group, an aryl group and aralkyl group, a halogen or a nitro group; m¹ may be an integer of 3 or more; n¹ may be an integer of 1 or more; and M may be a divalent or trivalent metal.

Another exemplary charge control agent may be represented by the following formula:

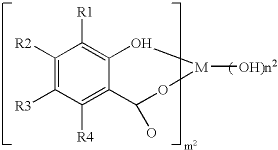

wherein each of R1 to R4 may be individually hydrogen, a hydroxyl group, a normal or branched alkyl group having 1 to 12 carbon atoms, an alkenyl group, an aryl group, and aralkyl group, a halogen or a nitro group; M may be a divalent or trivalent metal; each of m² or n² may represent a positive integer, wherein m²+n² may represent the oxidation number of the metal M.

Other exemplary charge control agents include metallic complexes of 3,5-di-t-butyl salicylic acid, which may also contain free (non-complexed) acidic functionality. Such exemplary charge control agent (aluminum based) is available from Orient Chemical Industries under the tradename Bontron E 108. Such CCA reportedly has a majority (>50%) of the salicylic acid component complexed with the metal, e.g. about 65% by weight metal complex and about 35% by weight of a non-complexed acidic component. Other exemplary metal complexes of 3,5-di-t-butyl salicylic acid that are contemplated herein may include metal complexes based upon Zn, Sr, Cr, Ti, Fe, Zr, Ni, Co, Mn, B, Si and Sn, and mixtures thereof.

The toner formulations herein may be prepared by chemical methods, which were described in general above. Again, the toner may be provided by combining the dispersions, polymeric latex and additives via mixing to form a slurry. After the initial mixing stage, the formulation may be mixed in a high shear mixer wherein the charge control agents noted above, at the indicated concentrations may be combined with the other materials in the toner formulation. Acid may then be added to the toner formulation. The acid may induce flocculation of the dispersions, latexes and additives into particles within the slurry. The slurry may be heated to a growth temperature. The growth temperature may be in the range of about 35° C. to 95° C., including all values and increments therein, such as 55° C. to 65° C. During acid addition and heating, the toner formulation may circulate through the high shear mixer. However, it should be appreciated that if the toner particles are agitated, they may be agitated via other processes. Heat may be applied to the slurry for a few minutes to 10 or more hours, including all values or increments therein, such as 2 to 6 hours.

The particles may be allowed to grow, via flocculation. The toner particles may then be fused at elevated temperatures in the range of about 90° C. to 150° C., including all values and increments therein, such as in the range of 100° C. to 130° C. Fusion may occur for a few seconds to a couple of hours including all values and increments therein, such as in the range of 10 to 210 minutes. Once again, the particles may be agitated during fusion. The toner formulation slurry may then be cooled and the toner particles may be removed from the slurry and dried.

Extra particulate agents may then be added to the dry toner particles. In an exemplary embodiment, the particles may be added to a high shear mixer and combined with a charge control agent and other optional additives. In a further exemplary embodiment, the charge control agent disclosed herein may be present, by weight percent, in a greater amount as an extra particulate additive rather than as an additive in the toner formulation itself.

The toner particles may also be relatively spherical and exhibit an average circularity in the range of greater than about 0.95, including all values and increments between 0.95-1.0. In addition, the average toner particle diameter may be in the range of about 2.0 to 15.0 μm, including all values and increments therein. As noted above, the number percent of fines in the toner may be less than 14.0%, such as in the range of 0.1 to 14.0%.

The toner may then be placed into an image forming apparatus or a cartridge. The toner may be utilized in developing images on media, wherein the toner may be transferred via differential charging from the image forming apparatus to a sheet of media. In a particular embodiment, the toner may be selectively transferred from a reservoir in the image forming apparatus or cartridge to form an image on a photoconductor drum and the toner may then be transferred to media.

It should be appreciated that the toner described above may be used in reducing the incidence of filming on components within the toner cartridge and/or printing apparatus. Filming may be understood at that situation where friction-induced heat development and/or pressing forces may provide that toner particles fuse to the surface of a given component (e.g. doctor blade or developer roller). As filming occurs, the toner may not stay uniformly on the component, and therefore, the density of an image may become uneven and/or a toner image may fail to be formed at a necessary position or some other image defect may be created. Therefore, it may be appreciated that filming may be more likely in those toners that may have a relatively higher percentage of fines than in those toners that have a relatively reduced percentage of fines.

In such a manner, and as demonstrated in the examples below, the use of the charge control agents described herein reduced the percentage of fines and therefore increased the amount of time before filming occurred and also increased the amount of time prior to failure due to filming of an exemplary developer roll component.

### EXAMPLES

The following examples are provided herein for purposes of illustration and are not meant to limit the scope of the description and claims appended hereto.

### Example 1

Two exemplary toner formulations for cyan toner were reacted in a 50 L reactor under identical conditions with the exception that formulation 1 included 2.0% charge control agent (CCA) and formulation 2 included 3.75% charge control agent (CCA). The toner was then finished with extra particulate agents and placed into a cartridge. The cartridge was inserted into a testing robot. The robot may indicate the propensity of the toner to film the various components within the cartridge or image forming device.

Various filming characteristics of the toner formulations were tested over an eight hour period including the number of hours for the developer roller to film and fail due to filming, wherein the greater the number of hours, the better the toner performance. In addition, the doctor blade and developer roll were visually examined and assessed on a scale of 0-4 at the end of the test, wherein a higher number indicates more filming and poorer performance. The testing results are illustrated in Table 1, below. For the parameters “Doctor Blade Film @ EOT (end of test)” and “Developer Roll Film @ EOT (end of test)” a higher value indicates relatively more filming and relatively poorer performance.

TABLE 1
Testing Results for Example 1.

| | Developer | | | |
|---|---|---|---|---|
| | Roll | | | |
| Toner | Filming | Developer Roll | Doctor Blade | Developer Roll |
| Formulation | (Hours) | Failure (Hours) | Film @ EOT | Film @ EOT |
| 2.0% CCA | 2 | 7 | 0 | 4 |
| 3.75% CCA | 7 | N/A | 0 | 2 |

As can be seen from Table 1 above, with an increase in the amount of charge control agent the degree of filming appeared to decrease.

### Example 2

Two exemplary toner formulations for yellow toner were reacted in a 50 L reactor under identical conditions with the exception that formulation 1 included 2.0% charge control agent (CCA) and formulation 2 included 3.75% charge control agent (CCA). The toner was then finished with extra particulate agents and placed into a cartridge. The cartridge was inserted into a testing robot. The robot may indicate the propensity of the toner to film the various components within the cartridge or image forming device.

Once again, various filming characteristics of the toner formulations were tested over an eight hour period including the number of hours for the developer roller to film and fail due to filming, wherein the greater the number of hours, the better the toner performance. In addition, the doctor blade and developer roll were visually examined and assessed on a scale of 0-4 at the end of the test, wherein a higher number indicates more filming and poorer performance. The testing results are illustrated in Table 2, below.

TABLE 2
Testing Results for Example 2.

| | Developer | | | |
|---|---|---|---|---|
| | Roll | | | |
| Toner | Filming | Developer Roll | Doctor Blade | Developer Roll |
| Formulation | (Hours) | Failure (Hours) | Film @ EOT | Film @ EOT |
| 2.0% CCA | 1 | 5 | 0 | 3 |
| 3.75% CCA | 1 | 8 | 0 | 3 |

As can be seen from Table 2 above, with an increase in the amount of charge control agent, the degree of filming appeared to decrease, and in particular with respect to the amount of time it took before the failure of the developer roll.

### Example 3

Four toner formulations were prepared utilizing 0 to 3.75 percentage by weight of CCA. The toner formulations were then characterized by average circularity for particles between 2 to 15 μm, average particle diameter for particles between 0.6 to 15 μm, and number percent of fines. Table 3 demonstrates that at 3.75% CCA, the fines in the toner is reduced to less than 5%. However, those formulations at 2% CCA or less produced fines present above 14%. In addition, the average degree of circularity may be maintained at a value of greater than about 0.95. Average degree of circularity may be measured by a Sysmex FPIA-2100 Flow Particle Image Analyzer. An average degree of circularity of 1.0 describes a perfect sphere. As may be appreciated, when the average degree of circularity is less than about 0.95, the toner particles may have flow problems which may then impact on the quality of any final image that may be produced.

TABLE 3
Changes in Toner Properties based on Percent CCA

| | | Degree Of | Avg. Particle | % Fines |
|---|---|---|---|---|
| Sample | | Circularity | Diameter (Vol) | (0.6–4.0 μm) |
| I.D. | Description | (Average) | 0.6–15 μm | (number based) |
| 1 | 3.75% CCA | 0.961 | 6.0 | 4.7 |
| 2 | 2.0% CCA | 0.971 | 5.6 | 14.3 |
| 3 | 1.0% CCA | 0.968 | 5.7 | 15.8 |
| 4 | 0.0% CCA | 0.960 | 5.5 | 14.9 |

The foregoing description of several methods and an embodiment of the invention has been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

What is claimed is:

1. A method of forming a toner composition and controlling the toner particle diameter distribution comprising:
mixing a pigment and wax dispersion with a polymeric latex and a charge control additive;
adjusting the concentration of said charge control additive between about 2.5 to about 5.0% by weight to control said toner particle diameter distribution;
forming toner particles and fusing said particles, wherein said adjustment of charge control additive concentration provides a mixture of toner particles having diameters (D₁) greater than about 4.0 μm and particles having diameters (D₂) less than about 4.0 μm, wherein particles having diameter D₂ are present in an amount of less than about 14.0%.

2. The method of claim 1 wherein said particles having a diameter D₂ are present in an amount of about 0.1 to about 5.0%.

3. The method of claim 1 wherein diameter D₂ comprises diameters of about 0.5 to about 4.0 μm.

4. The method of claim 1, wherein said charge control additive is a metal complex of an aromatic acid.

5. The method of claim 1, wherein said charge control additive is a metal complex of 3,5-di-t-butyl salicylic acid, including non-complexed 3,5-di-t-butyl salicylic acid, wherein the metal complex is present in an amount of greater than or equal to about 50%.

6. The method of claim 1, wherein said particles have an average circularity of greater than or equal to about 0.95.

7. The method of claim 1, further comprising transferring said toner into a printer cartridge.

8. A method of forming a toner composition and controlling the toner particle diameter distribution comprising:
mixing a pigment and wax dispersion with a polymeric latex and a charge control additive;
adjusting the concentration of said charge control additive between about 2.5 to about 5.0% by weight to control said toner particle diameter distribution;
forming toner particles and fusing said particles, wherein said adjustment of charge control additive concentration provides a mixture of toner particles having diameters (D₁) greater than about 4.0 μm and particles having diameters (D₂) of about 0.5 to about 4.0 μm, wherein particles having diameter D₂ are present in an amount of about 0.1 to about 5.0%, and wherein said particles have an average degree of circularity of greater than or equal to about 0.95.

9. The method of claim 8 wherein said charge control additive is a metal complex of 3,5-di-t-butyl salicylic acid, including non-complexed 3,5-di-t-butyl salicylic acid, wherein the metal complex is present in an amount of greater than or equal to about 50%.

10. The method of claim 8 further comprising transferring said toner into a printer cartridge.

11. A toner composition comprising:
chemically processed toner comprising pigment, wax, charge control agent and a polymer binder, wherein the charge control additive is present at about 2.5 to about 5.0% by weight;
said toner comprising a mixture of particles having diameters (D₁) greater than about 4.0 μm and particles having diameters (D₂) less than about 4.0 μm, wherein particles having diameter D₂ are present in an amount of less than about 14.0%.

12. The toner composition of claim 11 wherein said particles having a diameter D₂ are present in an amount of about 0.1 to about 5.0%.

13. The toner composition of claim 11 wherein said diameter D₂ comprises diameters of about 0.6 to about 4.0 μm.

14. The toner composition of claim 11 wherein said toner particles have an average degree of circularity of greater than or equal to about 0.95.

15. The toner composition of claim 11 wherein said charge control additive is a metal complex of 3,5-di-t-butyl salicylic acid, including non-complexed 3,5-di-t-butyl salicylic acid, wherein the metal complex is present in an amount of greater than or equal to about 50%.

16. The toner composition of claim 11 wherein said toner composition is contained within a printer cartridge.

17. The toner composition of claim 11 wherein said toner composition is contained within a printer.
